(19) United States
(12) Patent Application Publication
(10) Pub. No.: US 2005/0223053 A1
(43) Pub. Date: Oct. 6, 2005

(54) Static floating point arithmetic unit for embedded digital signals processing and control method thereof

(76) Inventors: Tay-Jyi Lin, Hsinchu (TW); Hung-Yueh Lin, Hsinchu (TW); Chein-Wei Jen, Hsinchu (TW); Chih-Wei Liu, Hsinchu (TW); I-Tao Liao, Hsinchu (TW)

Correspondence Address: HARNESS, DICKEY & PIERCE, P.L.C., P.O. BOX 8910, RESTON, VA, 20195, US

(21) Appl. No.: 10/928,150

(22) Filed: Aug. 30, 2004

(30) Foreign Application Priority Data
Apr. 6, 2004 (TW) 93109481

(51) Int. Cl. G06F 7/38

(52) U.S. Cl. 708/495

(57) ABSTRACT

A floating point arithmetic unit for embedded digital signal processing is provided with the ability of tracking the exponent portion of numerals using static analyzing technology efficiently and of low-power consumption. A fix adding unit with a simplified mantissa alignment device and simplified normalizing device arranged at the input end and output end, a fix multiplying unit with a simplified normalizing device arranged at the output end, and a shifter are included in the floating point arithmetic unit. A shift control method in accordance the floating point arithmetic unit is also provided to prevent overflow of the peak of the numerals. According the unit and the method, the effective precision of the arithmetic result is higher. The hardware configuration, power consumption and chip area are similar with fix point arithmetic units, while the precision is close to the floating point arithmetic units with complicated configuration.

This Non-provisional application claims priority under 35 U.S.C. § 119(a) on Patent Application No(s). 093109481 filed in Taiwan on Arial 6, 2004, of which the entire contents are hereby incorporated by reference.

### BACKGROUND OF THE INVENTION

1. Field of Invention

The invention relates to a static floating arithmetic and control method thereof, and more particularly to a method which tracks exponents of floating point numbers using static analytic technology efficiently. Further, the invention relates to low-power consumption.

2. Related Art

An optical attenuator is conventionally used to attenuate light power, and constitute an important passive element in the field of optical engineering, especially in optical fiber system indicators and meters, signal attenuators of short-distance communication systems, etc.

Portable electronic products are more and more prevalent with development of technology, and meanwhile may support various wireless communication specification and instantaneous multimedia processing. Therefore, arithmetic units with higher efficiency and lower power consumption become the main technology development of consumer electronic products.

The method of floating point numbers, for example, IEEE 754 standard, is one of the most excellent technologies. It may provide relatively high precision within a very wide dynamic range. This is similar to the normal presentation of scientific numbers. Floating point arithmetic may deal with the mantissa alignment automatically through a series of comparing, checking and shifting. Current processors, for example CPUs in computer systems, support floating point arithmetic. Take a 32 bits single precision presentation as example. A floating point number is divided into three parts, sign digit, exponent portion, and mantissa portion, which occupy 1 bit, 8 bits and 32 bits respectively.

In addition to normalization, the exponent portion of each numeral needs to be checked. The mantissa portions of the operands are aligned and the calculated results are normalized. The hardware is very complicated and consumes large amounts of power, which may be affordable in a normal information system. However, for a portable device using batteries as power source, power consumption needs to be deeply considered. The convention floating point arithmetic architecture is not suitable for embedded digital signal processing of low power.

The current solution to this problem is to adopt an integer arithmetic unit to deal with fixed-point operation. Fixed-point operation does not align the mantissa or normalize the result. Therefore, precision is sacrificed for preventing overflow during software development. The engineer needs to shift by hand for meeting the dynamic range. Besides, large simulation is necessary for estimating the range of input numeral and output numeral to insert shift operation. In fixed-point operation, only some bits store the effective value for parameters with small numerals, and the former bits are reserved for dynamic range. Therefore, a large amount of effective precision is lost.

Current digital signal processors supporting floating point arithmetic, ex. C, C67 of TI or TigerSHARC of ADI, enable the engineers not to care about the dynamic range and the effective precision. However, the hardware is very complicated and consumes a large amount of power. At the contrary, digital signal processors supporting fix point arithmetic, ex. C5, C62 of TI or ADSP21xxof ADI, have hardware with low complicity. But a large amount of simulation and analysis is needed and ranges of numerals are estimated. The arithmetic numeral needs to be increased or decreased for preventing overflow. And mantissa alignment also proceeds for consecutive operation.

From the above illustration, a floating point arithmetic unit with high efficiency and low power consumption for embedded digital signal processing is necessary.

### SUMMARY OF THE INVENTION

In view of the foregoing problems, the main object of the invention is to provide a static floating point arithmetic unit to substantially abbreviate the problems and drawbacks in the prior art.

Another object of the invention is to provide a shift control method of the static floating points in accordance with the static floating points of the invention to track the exponent of a numeral and generate necessary control signals for shift control.

According to one aspect of the invention, the static floating point arithmetic unit of the invention includes an adding unit, a multiplying unit and a shift unit. The adding unit has an adder which has two input ends and one output end; a first mantissa alignment device and a second mantissa alignment device arranged at the input end of the adder for adjust mantissa position of a first numeral and a second numeral, and a first normalizer arranged at the output end of the adder for adjusting the magnitude of the calculating result between 0.5 and 1. The multiplying unit has a multiplier having two input ends and one output end; a second normalizer arranged at the output end of the multiplier for adjusting the magnitude of the calculating result between 0.5 and 1. The shift control unit has a shifter for performing arbitrary shift to the arithmetic result.

According to another aspect of the invention, the shift control method of the floating point arithmetic unit of the invention is capable of statically estimating the range of the calculating result after adding/subtracting or multiplying and automatically inserting shift operation, thereby adjusting the magnitude of the calculating result between 0.5 and 1. Therefore, the overflow of the result is prevented and the most usage of bits is reserved.

According to the static floating point arithmetic unit and shift control method thereof of the invention, the complexity, power consumption and the silicon area of the hardware configuration is similar to the fix point arithmetic unit.

According to the static floating point arithmetic unit and shift control method of the invention, the exponent portion is tracked automatically and the necessary control signals are generated accordingly. The precision is close to the floating point arithmetic unit in accordance with the static floating point arithmetic unit of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus does not limit the present invention, wherein:

FIG. 1 illustrates the configuration of the static floating point arithmetic unit in accordance with the invention;

FIG. 2 illustrates the adding operation of the static floating point arithmetic unit in accordance with the invention;

FIG. 3 is the example of the adding operation according to the overflow of determined criteria in accordance with the invention; and

FIG. 4 is the example of the multiplying operation according to the overflow of determined criteria in accordance with the invention.

### DETAILED DESCRIPTION OF THE INVENTION

The representation of a floating point includes a mantissa portion and an exponent portion. When the floating-point arithmetic unit adds floating point numbers, the mantissa portions of the two numbers to-be-added are shifted in order to make the exponent potions of the two numbers become the same. Then the arithmetic unit adds the mantissa portions. At last, the exponent portion of the calculated result is adjusted to make the mantissa portion maintain effective precision within a fixed range. When performing multiple operation, the floating-point arithmetic unit multiples the mantissa portions, and then adds the exponent portions. No matter multiplying or adding operation, the floating point arithmetic unit is capable of dynamically processing the mantissa portion and exponent portion of the numeral to maintain precision.

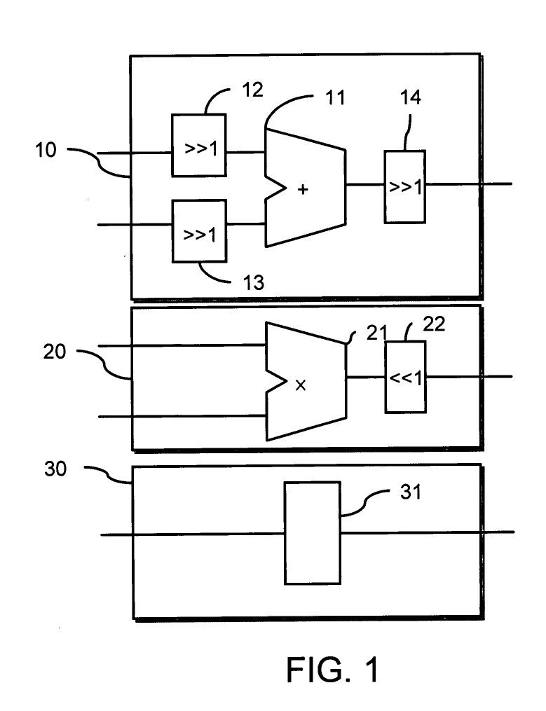

According to the principle in accordance with the invention, FIG. 1 illustrates the configuration of the static floating point arithmetic unit in accordance with the invention. The static floating point arithmetic unit is composed of an adding unit 10, a multiplying unit 20 and a shifting unit 30, which simulate floating point arithmetic for the adding and multiple calculations necessary for digital signal processing.

The adding unit 10 performs addition and subtraction of fix two's compliment and maintains precision of one more bits without losing precision because of shifting. The adding unit 10 includes an adder 11. A first mantissa alignment device 12 and a second mantissa alignment device 13 are arranged at the input end of the adder 11. A first normalizer 14 is provided at the output end of the adder 11 for normalizing numerals. The exemplary embodiments of the first mantissa alignment device 12, the second mantissa alignment device 13, and the first normalizer 14, for example, may comprise right shifters of which the word length is shorter than that of the numerals. The right shifters, for example, are one-bit right shifters.

When performing adding or subtracting operation, if one bit difference occurs in the exponent portion of the two numerals, the first mantissa alignment device 12 and the second mantissa alignment device 13 may align the two numerals directly. According to the principle of the invention, if the alignment bit exceeds one, a shifting unit 30 employs for shifting.

The multiplying unit is employed for a multiplying operation, which is composed of a multiplier 21 and a second normalizer 22. The multiplier 21 has two input ends. The second normalizer 22 is arranged at the output end of the multiplier 21. The exemplary embodiments of the second normalizer 22, for example, comprise of left shifters of which the word length is shorter than that of the numerals. The left shifters, for example, are one-bit left shifters.

The shifting unit 30 includes a shifter 31 for arbitrary shifting to the numerals. The shifter 31 executes a bit shift, which exceeds the bits of the right shifters. The shift control signal is generated through analyzing the dynamic range of the numerals by a software analyzing algorithm.

Therefore, according to the configuration of the static floating point arithmetic unit in accordance with the invention, an (N+1)-bit adder 11 and an N-bit multiplier 21 are needed for an N-bit numeral.

The operation according to the configuration of the invention adopts the same fractional number as floating point units. Because exponent portions need alignment before adding operation, a one-bit mantissa alignment device is employed. Compared with the conventional floating point unit, the hardware area and power consumption are largely reduced.

The exponent portion is performed by software, which tracks the position of the decimal point automatically and determines possible overflow. For multiplying operation, commensurable operation is executed automatically because of fractional number operation.

In other words, the core arithmetic according to the invention is similar to the conventional floating-point arithmetic unit. However, the alignment operation in accordance to the invention is not as complicated as the floating point arithmetic unit, and the hardware configuration according to the invention is similar to the conventional fixed point arithmetic unit. Furthermore, take a 24-bit arithmetic numeral for example; the static floating point unit in accordance to the invention has a higher precision. This is because the configuration according to the invention does not need to store respective exponent portion of each numeral, and leads to efficient bit usage for data processing.

According to one aspect in accordance with the invention, the corresponding control signal in accordance with the static floating point arithmetic unit and automatic track on the exponent portion are illustrated in details as follows.

The core algorithm is represented by Synchronous Data Flow Graph (SDFG). The numerals are analyzed by using the method provided by the invention, and are normalized and aligned. The dynamic range and the exponent portions of the numerals are also calculated. The shift operations during calculating are executed accordingly and corresponding control signals are generated likewise. The exponent portion of the calculated numeral is adjusted to be the same as that of the input numeral, and then the final results are put out. If the exponent portion of the output numeral exceeds the predetermined range, the maximum or minimum of the exponent portion are then adopted for output (saturation output).

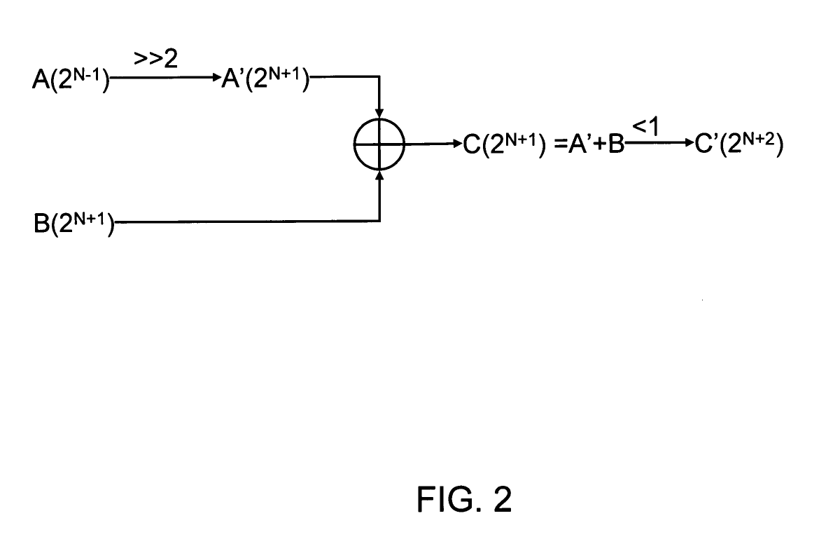

Refer to FIG. 2 showing the adding operation of a first numeral A and a second numeral B. The exponent portion of the first numeral A is 2^{N-1}, while that of the second numeral B is 2^{N+1}. Because the exponent portions of the numerals are not the same, the exponent portion of the first numeral A is left shifted by two bits before the adding operation becomes 2^{N+1} such, that the exponent portions of the numerals are the same. The exponent portion of the numeral C is 2^{N+1}. After the adding operation, the possible overflow of the numeral C is checked. If possible, the numeral C is right shifted by one bit for preventing overflow, and the exponent portion of the numeral C is 2^{N+2}.

The edge of the Synchronous Data Flow Graph is the parameter of the arithmetic core. A peak estimation vector (PEV) [M, r], which represents the magnitude and decimal point of the numeral, is employed in accordance with the invention. M stands for the magnitude, while r stands for the position of the decimal point, which is the mantissa portion in the floating-point number. Before adding or subtracting operation, r needs to be the same. Therefore, alignment of the numerals is preceded first. Multiplying of two numerals is calculated by [M1, r1]×[M2, r2]=[M1×M2, r1+r2]. When M is multiplied (divided) by 2, r is added (subtracted) by 1. It is specially noted that the numeral can not be represented for M>1 because of fractional number arithmetic algorithm in accordance with the invention. Therefore, the value of M has to be between 1˜0.5 for preventing overflow and keeping effective precision. When M is greater than 1, M is divided by 2 and r is subtracted by 1. When M is smaller than 0.5, M is multiplied by 2 and r is added by 1.

According to the above principle and the configuration illustrated in FIG. 1, the first mantissa alignment device 12 and the second mantissa alignment device 13 adjust the value of r for adding the numerals. The first normalizer 14 adjusts the value of M for keeping the value of M between 0.5˜1. If the shift is more than one bit, then the shifting unit 30 performs a shifting operation. For a multiplying operation, the second normalizer 22 adjusts the value of M between 0.5˜1.

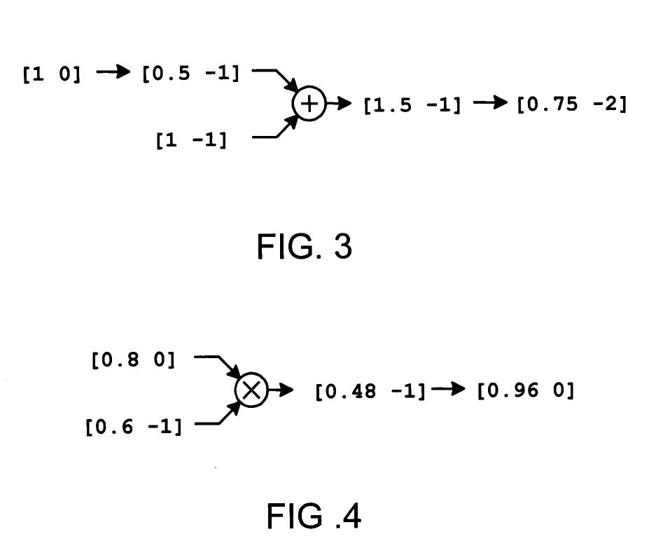

Refer to FIG. 3. The PEV of two fractional numbers are the first vector [1, 0] and the second vector [1, −1] respectively. According to the above principle, the value of r has to be aligned first, because it's different. The value of r of the first numeral is subtracted by 1 to become −1. The first vector becomes [0.5, −1]. After adding operation, it becomes [1.5, −1]. Because 1.5 is greater than 1, it is divided by 2 and the output PEV is [0.75, −2].

Refer to FIG. 4. A first vector [0.8, 0] and a second vector [0.6, −1] are multiplied. According to the above principle, the two numerals are multiplied directly and [0.48, −1] is obtained. Because 0.48 is less than 0.5, 0.48 is multiplied by 2 and the output PEV is [0.96, 0].

According to the above static analysis method, the Synchronous Data Flow Graph provided by users is analyzed point by point to obtain the PEV and the mantissa alignment of all numerals. Then, control signals are generated accordingly without checking the numerals dynamically performed by the conventional floating point arithmetic unit.

According to the principle of the invention,

A floating point arithmetic unit for embedded digital signal processing is provided with the ability of automatically tracking the exponent portion of numerals, using static analyzing technology efficiently and having low-power consumption. A fixed adding unit with a simplified mantissa alignment device and simplified normalizing device arranged at the input end and output end, a fixed multiplying unit with a simplified normalizing device arranged at the output end, and a shifter are included in the floating point arithmetic unit. A shift control method in accordance with the floating-point arithmetic unit is also provided to prevent overflow of the peak of the numerals and increase precision.

According to the unit and the method according to the invention, the effective precision of the arithmetic result is higher. The hardware configuration, power consumption and chip area are similar with fixed point arithmetic units, while the precision is close to the floating point arithmetic units with complicated configuration.

According the unit and the method according to the invention, the dynamic range and precision of the algorithm of floating point numbers may be analyzed and be converted into the shift and control signals in accordance with the static floating point arithmetic unit of the invention. Therefore, the user does not have to analyze the algorithm and may obtain the precision close to the floating-point arithmetic with hardware similar to a fixed arithmetic unit.

It will be apparent to the person skilled in the art that the invention as described above may be varied in many ways, and notwithstanding remaining within the spirit and scope of the invention as defined in the following claims.

1. A static floating point arithmetic unit for embedded digital signal processing, for performing floating point operation to at least one numeral and outputting an arithmetic result, comprising:
an adding unit for adding or subtracting the numerals and outing the arithmetic result, comprising:
an adder having two output ends and one output end;
a first mantissa alignment device and a second mantissa alignment device, which are arranged at the input ends of the adder respectively, for adjusting the mantissa portion of the numerals; and
a first normalizing device, which is arranged at the output end of the adder, for adjusting the arithmetic result between 0.5 and 1;
a multiplying unit for performing multiplying the numerals, comprising:
a multiplier having two input ends and one output end; and
a second normalizing device, which is arranged at the output end of the adder, for adjusting the arithmetic result between 0.5 and 1; and
a shifter for shifting the arithmetic result arbitrally.

2. The static floating point arithmetic unit of claim 1, wherein the first mantissa alignment device comprises a right shifter.

3. The static floating point arithmetic unit of claim 2, wherein the word length of the right shifter is less than the word length of the numeral.

4. The static floating point arithmetic unit of claim 3, wherein the right shifter is one-bit.

5. The static floating point arithmetic unit of claim 1, wherein the second mantissa alignment device comprises a right shifter.

6. The static floating point arithmetic unit of claim 5, wherein the word length of the right shifter is less than the word length of the numeral.

7. The static floating point arithmetic unit of claim 6, wherein the right shifter is one-bit.

8. The static floating point arithmetic unit of claim 1, wherein the first normalizing device comprises a right shifter.

9. The static floating point arithmetic unit of claim 8, wherein the word length of the right shifter is less than the word length of the numeral.

10. The static floating point arithmetic unit of claim 9, wherein the right shifter is one-bit.

11. The static floating point arithmetic unit of claim 1, wherein the second normalizing device comprises a left shifter.

12. The static floating point arithmetic unit of claim 11, wherein the word length of the left shifter is less than the word length of the numeral.

13. The static floating point arithmetic unit of claim 12, wherein the left shifter is one-bit.

14. A shift control method for a static floating point arithmetic unit applied in embedded digital signal processing with the ability of determining overflow of at least one arithmetic result, the numerals at the input end and the output end of the unit being represented by a vector of a peak and a mantissa, the method is characteristic in that:
the peak of the arithmetic result being adjusted between 0.5 and 1 through adjusting the mantissa of the numerals.

15. The shift control method of claim 14, wherein the arithmetic result is adjusted by a right shifter when the arithmetic result is generated by an adding or a subtracting operation.

16. The shift control method of claim 15, wherein the word length of the right shifter is less than the word length of the numeral.

17. The shift control method of claim 15, wherein the right shifter is one-bit.

18. The shift control method of claim 16, wherein shift of the arithmetic result exceeding the word length of the right shifter is finished by a shifter.

19. The shift control method of claim 11, wherein the arithmetic result is adjusted by a left shifter when the arithmetic result is generated by a multiplying operation.

20. The shift control method of claim 19, wherein the word length of the left shifter is less than the word length of the numeral.

21. The shift control method of claim 20, wherein the left shifter is one-bit.
